(19) United States
(12) Patent Application Publication
(10) Pub. No.: US 2026/0028472 A1
(43) Pub. Date: Jan. 29, 2026

(54) FLAME RETARDANT POLYCARBONATE COMPOSITIONS

(71) Applicant: SABIC GLOBAL TECHNOLOGIES B.V., Bergen op Zoom (NL)

(72) Inventors: Prashant PATIL, Bangalore (IN); Rukmini KHATOKAR, Bangalore (IN); Kumar Subodh PAL, Bangalore (IN); Susanta MITRA, Bangalore (IN); Vivek GAUR, Bangalore (IN)

(21) Appl. No.: 18/997,957

(22) PCT Filed: Jun. 27, 2023
(86) PCT No.: PCT/EP2023/067424

§ 371 Date: Jan. 23, 2025

(30) Foreign Application Priority Data
Jul. 27, 2022 (EP) 22187154.4

(51) Int. Cl. C08K 5/5399; C08L 69/00

(52) U.S. Cl. CPC C08K 5/5399; C08L 69/00; C08L 2201/02

(57) ABSTRACT

A flame retardant composition including A. 50 to 90 wt. % of a polycarbonate composition including from 15 to 85 wt. % based on the weight of the polycarbonate composition of a first polycarbonate and from 85 to 15 wt. % of a second polycarbonate, the first polycarbonate having a higher molecular weight than the second polycarbonate; B. 5 to 30 wt. % of glass fillers; C. 4 to 10 wt. % of a phosphazene compound; D. 0 to 10 wt. % of other components; wherein, the combined amounts of (A) to (D) is 100 wt. %, and wherein, the composition is selected to have: a heat distortion temperature of at least 110° C., as determined in accordance with ISO 75/A flatwise at a load of 1.8 MPa, and a flame retardancy of V-0 at a sample thickness of 0.8 millimeters when tested per UL-94 protocol.

### CROSS REFERENCE TO RELATED APPLICATIONS

This application is a National Stage application of PCT/EP2023/067424, filed Jun. 27, 2023, which claims the benefit of European Application No. 22187154.4, filed Jul. 27, 2022, both of which are incorporated by reference in their entirety herein.

### BACKGROUND

The present invention relates to a flame-retardant (FR) composition comprising a blend of two polycarbonates one of which has a higher molecular weight than the other, glass fillers and a phosphazene compound. The present invention further relates to an article comprising or consisting of such a composition.

Polycarbonate compositions comprising FR additive(s) are known per se in the prior art. It may be used in interior or exterior automotive applications and also in electrical & electronic applications such as handheld devices such as mobile phones or tablets, notebooks, monitors, data storage etc., computer, (tele) communication applications, across other different segments and applications. Such applications can be consumer products & appliances, automotive lighting, automotive under the hood, electric vehicle applications, electrical parts, electronic displays, energy storage and lighting applications.

In many of these applications there is a trend towards parts that, at least partially, have a relatively small wall thickness. As a result the compositions used for the manufacture of such applications requires an optimized set of flow and mechanical properties, such as in particular impact and stiffness, while maintaining good flame retardancy, such as in particular a UL V0 rating.

Various strategies for increasing the rigidity of polycarbonate resins have been examined, and the strategy of incorporating a fibrous reinforcement, e.g., a glass fiber, is the most effective in responding to the demand for high rigidity for thin-wall configurations. The incorporation of a halogenated flame retardant in the polycarbonate resin has been used as means for imparting flame retardancy to such glass fiber-reinforced polycarbonate resins. However, polycarbonate resin compositions that incorporate a halogenated flame retardant, which contains chlorine, bromine or fluorine, exhibit a reduction in thermal stability and during molding operations may cause corrosion of the screw and molding tools in the molding equipment.

Glass fiber-reinforced polycarbonate resin compositions that incorporate an organophosphate ester, such as phosphazene, are frequently used as an alternative strategy to the existing prior arts (refer, for example, to JPH1046017A, JPH1030056A, JP2006176612A and EP2810989B1). However, it is difficult to respond to the recent requirements for thin-wall flame retardancy using resin compositions that incorporate an organophosphate ester FR. Furthermore, the present inventors have found that the prior art compositions may not have the desired combination of rheological, mechanical and flame retardancy properties. Thus, there is a strong demand for a polycarbonate resin composition that presents an excellent balance between the flame retardancy and flowability, rigidity, impact resistance, and heat resistance.

US 2018/0142079 discloses a flame retardant composition comprising 20 to 80 weight percent of a polycarbonate; and 1 to 20 weight percent of a halogenated phenoxyphosphazene flame retardant, where all weight percentages are based on a total weight of the flame retardant composition.

US 2021/0095118 discloses a glass-filled polycarbonate composition comprising 5 to 95 wt. % of a high heat copolycarbonate component having a glass transition temperature of 170° C. or higher as determined per ASTM D3418 with a 20° C./min heating rate; a phosphorous-containing flame retardant present in an amount effective to provide about 0.2 to 0.9 wt. % of added phosphorous, based on the total weight of the phosphorous-containing flame retardant; 5 to 45 wt. % of glass fibers; optionally, 5 to 50 wt. % of a homopolycarbonate having a weight average molecular weight from 15,000 to 40,000 grams/mole, as measured via gel permeation chromatography using bisphenol A homopolycarbonate standards, and wherein each amount is based on the total weight of the glass-filled polycarbonate composition, which sums to 100 wt. %; wherein a molded sample of the glass-filled polycarbonate composition has a Vicat softening temperature of greater than or equal to 135° C. as measured according to ISO 306, and a flame test rating of VO as measured according to UL-94 at a thickness of 1.0 millimeter

### SUMMARY

In view of the foregoing, an object of the present invention is to provide a thermoplastic composition having a desired combination of thin wall FR performance, impact resistance, stiffness and flow which allows it to be suitable for the manufacture of thin walled structural parts.

This object is met, at least in part, in accordance with the present invention which is directed at a flame retardant composition comprising, based on the weight of the composition,
A. 50 to 90 wt. % of a polycarbonate composition comprising from 15 to 85 wt. % based on the weight of the polycarbonate composition of a first polycarbonate and from 85 to 15 wt. % of a second polycarbonate, the first polycarbonate having a higher molecular weight than the second polycarbonate;
B. 5 to 30 wt. % of glass fillers;
C. 3 to 10 wt. % of a phosphazene compound;
D. 0 to 10 wt. % of other components;
wherein, the combined amounts of (A) to (D) is 100 wt. %, and
wherein, the composition is selected to have:
   a heat distortion temperature of at least 110° C., preferably at least 120° C., as determined in accordance with ISO 75/A flatwise at a load of 1.8 MPa, and
   a flame retardancy of V-0 at a sample thickness of 0.8 millimeters when tested per UL-94 protocol.

### DETAILED DESCRIPTION

The present inventors in particular found that, compared to some compositions disclosed in the prior art, the use of expensive polycarbonate-polysiloxane copolymers or high-heat polycarbonate copolymers can be avoided if use is made of a synergistic effect, achieved when polycarbonate composition with a specific ratio of split between high molecular weight and low molecular weight polycarbonates, along with a phosphazene compound and glass fillers are used. Flamer retardancy properties of UL94 V0 at 0.8 mm can be obtained along with a good balance of heat and mechanical properties. Without being bound by it, the inventors believe that the ratio of split between the high molecular weight and low molecular weight polycarbonates in the polycarbonate composition of the present flame retardant composition is believed to be of relevance to achieve this balance of properties.

The invention will now be described in more detail.

### Polycarbonate (PC)

Aromatic polycarbonates are generally manufactured using two different technologies. In a first technology, known as the interfacial technology or interfacial process, phosgene is reacted with a bisphenol, typically bisphenol A (BPA) in a liquid phase. Another well-known technology is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. Aromatic polycarbonate obtained by the melt transesterification process is known to be structurally different from aromatic polycarbonate obtained by the interfacial process. In that respect, it is noted that in particular, the so called “melt polycarbonate” typically has a minimum amount of Fries branching, which is generally absent in “interfacial polycarbonate”. Apart from that, melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups.

The composition of the present invention comprises, as a component (A), 50 to 90 wt. % of a polycarbonate composition comprising from 15 to 85 wt. % based on the weight of the polycarbonate composition of a first polycarbonate and from 85 to 15 wt. % of a second polycarbonate. The amount of first polycarbonate is preferably from 25 to 75 wt. %, more preferably from 35 to 65 wt. %, based on the weight of the polycarbonate composition. The amount of second polycarbonate is preferably from 75 to 25 wt. %, preferably from 65 to 40 wt. %, based on the weight of the polycarbonate composition. It is preferred that the polycarbonate composition comprises, based on the weight of the polycarbonate composition, at least 80 wt. %, preferably at least 90 wt. %, more preferably at least 95 wt. % and even more preferably at least 99 wt. % of first and second polycarbonate. Accordingly it is preferred that the polycarbonate composition essentially consists or consists of the first and second polycarbonate. The polycarbonate composition may comprise a further polycarbonate, but preferably does not comprise a further polymer component not being a polycarbonate.

The first and second polycarbonate may have a weight average molecular weight from 25,000 to 60,000 Daltons, provided that the first polycarbonate has a higher molecular weight than the second polycarbonate. Preferably the first polycarbonate has a weight average molecular weight from 45,000 to 65,000 Daltons, preferably 50,000 to 60,000 Daltons, as measured by gel permeation chromatography using a polystyrene standard. The second polycarbonate may have a weight average molecular weight of from 25,000 to less than 45,000 g/mol, preferably from 30,000 to 40,000 g/mol, as measured by gel permeation chromatography using a polystyrene standard.

It is preferred that the polycarbonate composition comprises or consists of at least two bisphenol A polycarbonates, more preferably the polycarbonate composition consists of two bisphenol A polycarbonates. Thus, it is preferred that both the first polycarbonate and the second polycarbonate are bisphenol A polycarbonate homopolymers. In an aspect, the polycarbonate composition comprises or consists of two interfacial polycarbonates. In another aspect, comprises or consists of two melt polycarbonates. In yet another aspect, the polycarbonate composition comprises or consists of a mixture of an interfacial polycarbonate and a melt polycarbonate. The polycarbonate composition in accordance with the invention preferably does not comprise one or more polycarbonate-polysiloxane copolymers or one or more poly (carbonate-siloxane) copolymers such as those within the meaning of US 2021/0095118. More in general the polycarbonate composition preferably does not comprise any polycarbonate copolymers. The polycarbonate composition further preferably does not comprise a high heat copolycarbonate component having a glass transition temperature of 170° C. or higher as determined per ASTM D3418 with a 20° C./min heating rate. More specifically the polycarbonate composition preferably does not comprise high heat copolycarbonate component comprising a poly (carbonate-bisphenol phthalate ester) comprising 1-50 wt. % of aromatic carbonate units and 50-99 wt. % of bisphenol phthalate ester units, each based on the sum of the weight of the carbonate units and the bisphenol phthalate ester units; or a high heat copolycarbonate comprising high heat aromatic carbonate units derived from 1, 1-bis(4-hydroxyphenyl)-3,3,5-trimethyl-cyclohexane, N-phenyl phenolphthalein bisphenol, 4,4′-(I-phenylethylidene) bisphenol, 4,4′-(3,3-dimethyl-2,2-dihydro-I H-indene-1,1-diyl)diphenol, 1,1-bis(4-hydroxyphenyl) cyclododecane, 3,8-dihydroxy-5a, 1 0b-diphenylcoumarano-2′,3′,2,3-coumarane, or a combination thereof, preferably 1,1-bis(4-hydroxyphenyl)-3,3,5-trimethyl-cyclohexane, N-phenyl phenolphthalein bisphenol, or a combination thereof, and optionally, low heat aromatic carbonate units, preferably bisphenol A carbonate units; or a combination thereof. It is further preferred that apart from aromatic polycarbonate the polycarbonate composition as disclosed herein does not comprise non-aromatic polycarbonate.

The polycarbonate composition preferably has a melt volume rate (MVR), determined in accordance with ISO 1133 (300° C., 1.2 kg) of 1 to 50 cc/10 min, specifically 2 to 30 cc/10 min.

The polycarbonate composition may also comprise of at least one polycarbonate resin regenerated from used products (so-called recycled polycarbonate resin). The used products here can be exemplified by optical recording media such as optical disks; transparent vehicle components such as automotive window glass, automotive headlamp lenses, and windshields; containers such as water bottles; eyeglass lenses; and architectural elements such as soundproofing walls, glazing, and corrugated sheet. Also usable are nonconforming products; pulverized material obtained from, e.g., sprues and runners; and pellets obtained by melting the preceding. Recycled polycarbonate resin is preferably at most 60 wt. % and more preferably at most 40 wt. % of the polycarbonate composition present in the flame retardant composition of the present invention.

### Glass Fillers

The glass filler (B) in the present invention is present in an amount of from 5 to 30 wt. %, preferably from 8 to 20 wt. %, more preferably from 8 to 16 wt. %, based on the weight of the composition. At these proportions, the rigidity of the composition of the present invention can be effectively raised by the presence of the filler. The glass filler is at least one selected from glass fibers, glass flakes, milled glass fibers, and glass beads, preferably the glass filler is a glass fiber.

The so called E-glass fiber, also known as lime-alumino-borosilicate glass is preferred. For achieving optimal mechanical properties the glass fiber diameter is from 6-20 micrometer, preferably from 10-15 micrometer. In preparing the compositions it is convenient to use the fiber in the form of chopped strands of from 3 to 15 mm in length although roving may also be used. In articles molded from the compositions, the fiber length is typically shorter due to fiber breakage during compounding or extrusion of the composition. The length of such short (i.e. shortened) glass fibers present in final molded compositions may be less than 4 mm. The glass fibers may be treated with a sizing agent to improve adhesion to the resin matrix. Preferred sizing agents include amino, epoxy, amide or mercapto functionalized silanes.

### Phosphazene Compound

The phosphazene compound (C) used in the present invention is an organic compound that has the —P═N— bond in the molecule. The amount of phosphazene compound, in the flame retardant composition is from 4 to 10 wt. %, preferably from 5 to 7 wt. % based on the weight of the composition.

The phosphazene compound may have a structure represented by the formula (I)

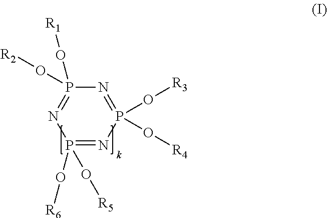

wherein R₁ to R₆ can be the same or different and can be an aryl group, an aralkyl group, a C1-12 alkoxy, a C1-12 alkyl, or a combination thereof and k is an integer from 1 to 10, preferably from 1 to 8. The phosphazene compound in accordance to the structure (I) can be used either alone or as a mixture. The radicals R₁ to R₆ in the structure (I) can be the same or different. The radicals R₁ to R₆ of the phosphazene compound of the present invention are preferably identical. In a further preferred embodiment, only phosphazenes having identical radicals R₁ to R₆ are used.

Preferably the phosphazene compound comprises a cyclic phosphazene according to the structure (I) having a proportion of oligomers having k=1 (trimer) from 50 to 98 mol % preferably from 70 to 90 mol % and more preferably 70-85 mol %.

The phosphazene compound may be selected from the group consisting of propoxyphosphazene, phenoxyphosphazene, and methylphenoxyphosphazene. Preferably, the phosphazene compound comprises of at least 50 wt. % of phenoxyphosphazene, preferably from 50 wt. % to 100 wt. % of phenoxyphosphazene, most preferably the phosphazene compound consists of phenoxyphosphazene. In one aspect of the invention, the phosphazene compound comprises or consists of phenoxyphosphazene according to structure (I-a), wherein k=1 and having a proportion of oligomers from 50 to 98 mol %.

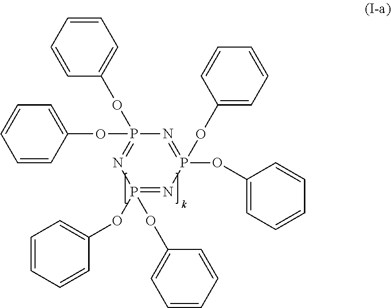

The phosphazene compound in accordance with the invention preferably does not comprise a halogenated phosphazene. In other words the phosphazene compound is preferably a halogen free phosphazene compound. More specifically the phosphazene compound preferably does not comprise fluorinated phenoxyphosphazene such as trifluorophenoxyphosphazene.

### Other Components

The flame retardant composition in accordance with the present invention comprises, based on the weight of the composition 0 to 10 wt. % of other components (D).

In particular, the other components (D) may comprise 1 to 5 wt. % (based on the weight of the composition) of a flame retardant synergist; selected from one or more of a polysiloxane-polycarbonate copolymer, a polysiloxane, a polyimide and a polyetherimide. The flame retardant synergist facilitates an improvement in the flame retardant properties when added to the flame retardant composition over a comparative composition that contains all of the same ingredients in the same quantities except for the flame retardant synergist.

In another aspect, the other components in accordance with the present invention may comprise, based on the weight of the composition, from 0.01 to 2 wt. % of anti-drip agent, preferably selected from one or more of PTFE and SAN encapsulated PTFE.

In yet another aspect, the other components in accordance with the present invention may comprise, based on the weight of the composition, from 0.01 to 3 wt. % of one or more selected from the group consisting of talc, kaolin and mica.

Other components that are used in the composition can comprise one or more of lubricants and mold release agents (for example pentaerythritol tetrastearate), nucleating agents, stabilizers, antistatics (for example conductive carbon blacks, carbon fibers, carbon nanotubes and organic antistatics, such as polyalkylene ethers, alkylsulfonates or polyamide-containing polymers), acids, fillers, reinforcing substances, (for example glass fibers or carbon fibers, mica, kaolin, talc, CaCO₃ and glass flakes) dyestuffs and pigments.

### Composition

The combination of specific types and amounts materials constituting the flame retardant composition results in a property profile in terms of a particular FR performance, toughness, stiffness and flow. The examples and comparative examples disclosed herein provide the skilled person with materials that fall inside and outside the scope of the invention respectively, and thereby constitute a basis for the development of further embodiments according to the invention without undue burden.

In accordance with the invention the flame retardant composition comprises, based on the weight of the composition,
A. 50 to 90 wt. % of a polycarbonate composition comprising from 15 to 85 wt. % based on the weight of the polycarbonate composition of a first polycarbonate and from 85 to 15 wt. % of a second polycarbonate, the first polycarbonate having a higher molecular weight than the second polycarbonate;
B. 5 to 30 wt. % of glass fillers;
C. 4 to 10 wt. % of a phosphazene compound;
D. 0 to 10 wt. % of other components;
   wherein, the combined amounts of (A) to (D) is 100 wt. %.

The amount of polycarbonate composition (A) may be from 60 to 90 wt. %, more preferably from 70 to 80 wt. %.

The amount of glass filler (B) may be from 8 to 20 wt. %, more preferably from 8 to 16 wt. %.

The amount of phosphazene compound (C) may be from 5 to 7 wt. %, more preferably from 4 to 6 wt. %.

The amount of other components (D) may be from 1 to 5 wt. %, more preferably from 1 to 3 wt. %.

For the avoidance of doubt the skilled person will understand that the total weight of the composition will be 100 wt. % and that any combination of materials which would not form 100 wt. % in total is unrealistic and not according to the invention.

It is preferred that the polycarbonate composition (A) comprises, based on the weight of the polycarbonate composition, at least 80 wt. %, preferably at least 90 wt. %, more preferably at least 95 or 99 wt. % of the first and second polycarbonate. Preferably the polycarbonate composition essentially consists or consists of the first and second polycarbonate

In accordance with the invention the thermoplastic composition is selected to have
a heat distortion temperature of at least 110° C., preferably at least 120° C., as determined in accordance with ISO 75/A flatwise at a load of 1.8 MPa, and
a flame retardancy of V-0 at a sample thickness of 0.8 millimeters when tested per UL-94 protocol.

It is preferred that the composition is selected to have a melt volume rate determined in accordance with ISO 1133 (300° C., 1.2 kg) of at least 9.0 cc/10 min, preferably from 10.0-20.0 cc/10 min, more preferably from 12.0-16.0 cc/10 min.

It is also preferred that the composition is selected to have a tensile modulus determined in accordance with accordance with ISO 527 at a temperature of 23° C. of at least 3500 MPa, preferably from 3800 to 10000 MPa.

It is further preferred that the composition is selected to have an unnotched Izod impact strength determined in accordance with ISO 180-1 U at a temperature of 23° C. of at least 30 KJ/m², preferably at least 70 KJ/m², more preferably at least 130 kJ/m², most preferably from 135 to 170 KJ/m².

Preferred ranges for the amount of the components and preferred ranges for the properties of the composition may be combined without limitation, provided of course that these fall within the scope of the invention as defined herein in its broadest form. That is to say, a preferred range for one or more of the amounts and/or types of the components constituting the thermoplastic composition may be combined with a preferred range for one or more of the properties of the thermoplastic composition and all such combinations are considered as disclosed herein.

The compositions can be manufactured by various methods known in the art. For example, polycarbonate, glass fillers, flame retardant additives and other additives are first blended, in a high-speed mixer or by hand mixing. The blend is then fed into the throat of a twin-screw extruder via a hopper. Alternatively, at least one of the components can be incorporated into the composition by feeding it directly into the extruder at the throat and/or downstream through a side feeder, or by being compounded into a master-batch with a desired polymer and fed into the extruder. For example, compositions can be prepared using a Krupp Werner & Pfleiderer ZSK2 co-rotating intermeshing 10-barrel twin screw extruder of diameter 25 mm and L/D ratio of 41. The temperature in the extruder may be from 180° C.-265° C. along the screw length. The extrudate can be immediately cooled in a water bath and pelletized. The pellets so prepared can be 0.6 cm in length or less as desired. Such pellets can be used for subsequent molding, shaping, or forming.

Shaped, formed, or molded articles comprising the compositions are also provided. The compositions can be molded into articles by a variety of methods, such as injection molding, extrusion, and thermoforming. Some example of articles include articles used in interior or exterior automotive applications and also in electrical & electronic applications such as software products (mobiles, notebooks, monitors, tablets, data storage etc.) computer and (tele) communication applications and across other different segments and applications such as consumer products & appliances, automotive lighting, automotive under the hood, electric vehicle applications, electrical parts, electronic displays, energy storage and lighting applications.

Accordingly, the present invention relates to an article comprising or consisting of the composition disclosed herein. More in particular, the present invention relates to manufacture of an article, preferably an automotive part or electrical or electronic part comprising or consisting the composition disclosed herein. Likewise, the present invention relates to a vehicle or an electrical or electronic equipment comprising said vehicular part or said electrical or electronic part.

The present invention will now be further elucidated based on the following non-limiting examples.

### Test Methods

| | |
|---|---|
| Impact (UNII) | Unnotched Izod impact (UNII) properties were determined in |
| | accordance with ISO 180/1U on injection molded samples of |
| | thickness 4.0 mm. The test was carried out at temperatures 23° C. |
| | The impact strength is expressed in kJ/m². The test result presented |
| | herein is the average of 10 specimens. |
| Tensile modulus | Tensile modulus was determined in accordance with ISO 527 at a |
| | temperature of 23° C. |
| Tensile strength | Tensile strength was determined in accordance with ISO 527 at a |
| | temperature of 23° C. |
| Elongation at break | Tensile yield, or elongation at break, was determined in accordance |
| (EB) | with ISO 527 at a temperature of 23° C. |
| Molecular weight | The molecular weight of the polycarbonate was measured by GPC |
| | method with polystyrene standard in an Agilent 1260 Infinity (SYS- |
| | LC-1260) equipment with PLGel 5 μm Minimix C 250 × 4.6 mm column |
| | and Refractive Index detector. The sample is dissolved in |
| | dichloromethane and the same solvent is used as carrier. |
| Heat distortion | The heat distortion temperature, HDT (in ° C.) was determined in |
| temperature (HDT) | accordance with ISO 75/A flatwise at a load of 1.8 MPa. Sample size |
| | was in accordance with the standard, i.e. a length of 80 ± 2.0 mm; a |
| | width of 10 ± 0.2 mm and a thickness of 4 ± 0.2 mm. |
| Flammability | UL 94 V (measured on bars of dimensions 127 × 12.7 × 1.0 mm and |
| | 127 × 12.7 × 0.8 mm respectively |
| | The total flameout time (TFOT) is the sum of the time, in seconds (s) |
| | measured according to the process described in UL-94 V test. |
| | The test result presented herein is the average of 5 specimens. |
| Melt volume rate | The melt volume rate was determined in accordance with ISO 1133. |
| (MVR) | Measurements were carried out at a temperature of 300° C. and a |
| | load of 1.2 kg. |

### EXAMPLES

The samples were molded by injection molding on L&T ASWA 100T Injection molding machine set from 40-280° C. and mold set at 80°. The components of the compositions and their source are listed in Table 1.

TABLE 1
Components of the compositions and their source

| Component | Trade name/Supplier |
|---|---|
| PC1 | Bisphenol A polycarbonate manufactured using an interfacial process, |
| | having a melt volume rate of 6 cc/10 min (ISO 1133, 300° C., 1.2 kg) and |
| | weight average molecular weight = 58,000 g/mol (with polystyrene |
| | standard) available from SABIC (PC 105) |
| PC2 | Bisphenol A polycarbonate manufactured using an interfacial process, |
| | having a melt volume rate of 13 cc/10 min (ISO 1133, 300° C., 1.2 kg) |
| | and weight average molecular weight = 42,000 g/mol (with polystyrene |
| | standard) available from SABIC (PC 175) |
| PC3 | Polycarbonate produced via the melt transesterification of diphenyl |
| | carbonate and bisphenol A, and having a melt volume rate of 6 cc/10 min |
| | (ISO 1133, 300° C., 1.2 kg) available from SABIC (PC 102L) |
| PC4 | Polycarbonate produced via the melt transesterification of diphenyl |
| | carbonate and bisphenol A, and having a melt volume rate of 13 |
| | cc/10 min (ISO 1133, 300° C., 1.2 kg) available from SABIC (PC 172L) |
| Quencher | Butyl tosylate quencher available from SABIC |
| GF | 10 micron diameter non bonded Glass fiber (chopped strands E-Glass |
| | Fibers) available from NEG (Nippon Electric Glass) |
| FR1 | Rimar salt (potassium diphenylsulfon-3-sulphonate) Bayowet C4 |
| | available from Lanxess |
| FR2 | Cyclic Phenoxyphosphazene oligomer FR, grade name Rabitle FP-110 |
| | available from Fushimi Pharmaceutical |
| PCSi | Polycarbonate made by interfacial route from Bisphenol A & Phosgene |
| | with 20% Siloxane content and having a melt volume rate of 6 cc/10 min |
| | (ISO 1133, 300° C., 1.2 kg) available from SABIC (EXL-PC) |
| PSi | Octaphenylcyclotetrasiloxane, available from Sigma Aldrich (CAS no. |
| | 546-56-5) |
| PEI | Unreinforced amorphous polyetherimide (PEI) resin available from |
| | SABIC (ULTEM 1010 Resin) |
| TSAN | SAN encapsulated PTFE available from SABIC (CAS No. 9003-54-7) |
| PETS | Pentaerythritol tetrastearate (CAS No. 115-83-3) |
| AO1 | Primary antioxidant, Pentaerythritol tetrakis(3-(3,5-di-tert-butyl-4- |
| | hydroxyphenyl)propionate), CAS No. 6683-19-8, Commercially available |
| | as Irganox 1010 |
| UV1 | UV5411 Benztriazole Stabilizer, available from CIBA |

TABLE 2
COMPARATIVE EXAMPLES (CE1-CE4) AND EXAMPLES (E1-E11)

| Sample # | CE1 | CE2 | CE3 | CE4 | E1 | E2 | E3 | E4 |
|---|---|---|---|---|---|---|---|---|
| PC1 | | 31.0 | 30.3 | 67.1 | 56.1 | 56.6 | 29.3 | 28.6 |
| PC2 | 85.0 | 57.5 | 55.4 | 7.9 | 28.1 | 28.6 | 54.4 | 53.1 |
| PC3 | | | | | | | | |
| PC4 | | | | | | | | |
| FR1 | | 0.2 | | | | | | |
| FR2 | 4.0 | | 3.0 | 4.0 | 4.0 | 4.0 | 5.0 | 7.0 |
| TSAN | 0.5 | 0.5 | 0.5 | 0.5 | 0.5 | 0.5 | 0.5 | 0.5 |
| PETS | 0.3 | 0.3 | 0.3 | 0.3 | 0.3 | 0.3 | 0.3 | 0.3 |
| AO1 | 0.05 | 0.05 | 0.05 | 0.05 | 0.05 | 0.05 | 0.05 | 0.05 |
| UV1 | 0.15 | 0.15 | 0.15 | 0.15 | 0.15 | 0.15 | 0.15 | 0.15 |
| Quencher | | 1.0 | 1.0 | | 1.0 | | 1.0 | 1.0 |
| GF | 10.0 | 9.3 | 9.3 | 20.0 | 9.8 | 9.8 | 9.3 | 9.3 |
| Total | 100.0 | 100.0 | 100.0 | 100.0 | 100.0 | 100.0 | 100.0 | 100.0 |
| UNII @ | 131 | 131 | NM | 70.8 | 165 | 150 | 131 | 73 |
| 23° C., | | | | | | | | |
| kJ/m2 | | | | | | | | |
| HDT, ° C. | 119 | 121 | NM | 123 | 118 | 121 | 118 | 111 |
| UL-94 @ | V2 | V1 | None | V0 | V0 | V0 | V0 | V0 |
| 1.0 mm | | | | | | | | |
| TFOT @ | 29 | 63 | NM | 24 | 38 | 26 | 47 | 29 |
| 1.0 mm | | | | | | | | |
| (s) | | | | | | | | |
| UL-94 @ | V2 | None | None | V1 | V0 | V0 | V0 | V0 |
| 0.8 mm | | | | | | | | |
| TFOT @ | 45 | NM | NM | 27 | 43 | 29 | 28 | 29 |
| 0.8 mm | | | | | | | | |
| (s) | | | | | | | | |
| MFR, | 23 | 10 | NM | 7 | 10 | 9 | 13 | 14 |
| cc/10 min | | | | | | | | |
| Tensile | 3878 | 4271 | NM | 6050 | 3839 | 3745 | 4124 | 4221 |
| Modulus | | | | | | | | |
| (Mpa) | | | | | | | | |
| Tensile | 57 | 58 | NM | 57 | 56 | 57 | 57 | 59 |
| Strength | | | | | | | | |
| (Mpa) | | | | | | | | |
| EB in % | 11 | 10 | NM | 5 | 11 | 11 | 9 | 7 |

| Sample # | E5 | E6 | E7 | E8 | E9 | E10 | E11 |
|---|---|---|---|---|---|---|---|
| PC1 | | | 55.6 | 57.1 | 17.9 | 10.0 | 55.0 |
| PC2 | | | 27.6 | 17.9 | 57.1 | 55.0 | 10.0 |
| PC3 | 56.1 | 56.6 | | | | | |
| PC4 | 28.1 | 28.6 | | | | | |
| FR1 | | | | | | | |
| FR2 | 4.0 | 4.0 | 4.0 | 4.0 | 4.0 | 4.0 | 4.0 |
| TSAN | 0.5 | 0.5 | 0.5 | 0.5 | 0.5 | 0.5 | 0.5 |
| PETS | 0.3 | 0.3 | 0.3 | 0.3 | 0.3 | 0.3 | 0.3 |
| AO1 | 0.05 | 0.05 | 0.05 | 0.05 | 0.05 | 0.05 | 0.05 |
| UV1 | 0.15 | 0.15 | 0.15 | 0.15 | 0.15 | 0.15 | 0.15 |
| Quencher | 1.0 | | | | | | |
| GF | 9.8 | 9.8 | 11.8 | 20.0 | 20.0 | 30.0 | 30.0 |
| Total | 100.0 | 100.0 | 100.0 | 100.0 | 100.0 | 100.0 | 100.0 |
| UNII @ | 121 | 125 | 129 | 64 | 61 | 37 | 37 |
| 23° C., | | | | | | | |
| kJ/m2 | | | | | | | |
| HDT, ° C. | 120 | 121 | 121 | 122 | 120 | 121 | 122 |
| UL-94 @ | V0 | V0 | V0 | V0 | V0 | V0 | V0 |
| 1.0 mm | | | | | | | |
| TFOT @ | 15 | 34 | 36 | 36 | 45 | 46 | 34 |
| 1.0 mm | | | | | | | |
| (s) | | | | | | | |
| UL-94 @ | V0 | V0 | V0 | V0 | V0 | V0 | V0 |
| 0.8 mm | | | | | | | |
| TFOT @ | 35 | 31 | 27 | 31 | 39 | 38 | 29 |
| 0.8 mm | | | | | | | |
| (s) | | | | | | | |
| MFR, | 11 | 13 | 9 | 8 | 17 | 16 | 5 |
| cc/10 min | | | | | | | |
| Tensile | 3876 | 3802 | 4118 | 5887 | 5978 | 9022 | 9388 |
| Modulus | | | | | | | |
| (Mpa) | | | | | | | |
| Tensile | 58 | 57 | 57 | 58 | 58 | NM | NM |
| Strength | | | | | | | |
| (Mpa) | | | | | | | |
| EB in % | 11 | 12 | 10 | 5 | 5 | 3 | 3 |

NM means Not Measured

The amounts in Table 1 are in weight percent based on the total weight of the composition. In all the examples, the total amount of components, equals 100 weight percent. Table 1 shows that flame retardant compositions comprising only one kind of polycarbonate (CE1) or comprising a different FR compound other than the phosphazene compound of the present invention (CE2) or a lower wt. % of the phosphazene compound than claimed in the present invention (CE3), are not in accordance with the claimed invention and do not show a desired flammability property in terms of UL94 V0 at 0.8 mm.

However, a flame retardant composition comprising a polycarbonate composition with a specific ratio of split between high molecular weight and low molecular weight polycarbonates, along with a phosphazene compound and glass fillers (E1 and E2) does show flame retardancy properties in terms of achieving UL94 V0 at 0.8 mm along with a good balance of heat and mechanical properties. The ratio of split between the high molecular weight and low molecular weight polycarbonates in the polycarbonate composition of the present flame retardant composition is believed to be of relevance to achieve this balance of properties and UL94 V0 at 0.8 mm. This is demonstrated in CE4, wherein the ratio of the high molecular weight and low molecular weight polycarbonates is not in accordance with the present invention and it is found that either the UL94 V0 at 0.8 mm is not achieved or the MVR is less than the desired range or both. E3 and E4 demonstrates the effect of the invention for a higher concentration of the phosphazene compound within the claimed limits.

It is also evident that similar properties are achieved when the composition comprises polycarbonate prepared by either interfacial process (E2 and E3) or by melt process (E5 and E6). Examples E8 to E11 comprises higher wt. % of the glass filler within the claimed limits along with the required wt. % spilt of the two polycarbonates used in the present invention. All of them demonstrates the effect of the invention in terms of achieving UL94 V0 at 0.8 mm along with a good balance of heat and mechanical properties. In all the experimental data (E1 to E11), it was found that within the ranges of the claimed invention, the composition shows a desired flammability property (UL94 V0 at 0.8 mm). Also in all the examples (E1 to E8), the HDT, UNII and the MFR is within the acceptable range as claimed in the invention.

1. A flame retardant composition comprising, based on the weight of the composition,
A. 50 to 90 wt. % of a polycarbonate composition comprising from 15 to 85 wt. % based on the weight of the polycarbonate composition of a first polycarbonate and from 85 to 15 wt. % of a second polycarbonate, the first polycarbonate having a higher molecular weight than the second polycarbonate;
B. 5 to 30 wt. % of glass fillers;
C. 4 to 10 wt. % of a phosphazene compound;
D. 0 to 10 wt. % of other components;
wherein, the combined amounts of (A) to (D) is 100 wt. %, and
wherein, the composition is selected to have:
a heat distortion temperature of at least 110° C., as determined in accordance with ISO 75/A flatwise at a load of 1.8 MPa, and a flame retardancy of V-0 at a sample thickness of 0.8 millimeters when tested per UL-94 protocol.

2. The flame retardant composition of claim 1 wherein the amount of phosphazene compound is from 5 to 7 wt. %.

3. The flame retardant composition of claim 1, wherein the first polycarbonate has a weight average molecular weight of 45,000 to 65,000 g/mol, as measured by gel permeation chromatography using a polystyrene standard.

4. The flame retardant composition of claim 1, wherein the amount of first polycarbonate is from 25 to 75 wt. %, based on the weight of the polycarbonate composition.

5. The flame retardant composition of claim 1, wherein the second polycarbonate has a weight average molecular weight of 25,000 to 45,000 g/mol as measured by gel permeation chromatography using a polystyrene standard.

6. The flame retardant composition of claim 1, wherein the amount of second polycarbonate is from 75 to 25 wt. %, based on the weight of the polycarbonate composition.

7. The flame retardant composition of claim 1, wherein the polycarbonate composition comprises or consists of at least two bisphenol A polycarbonates.

8. The flame retardant composition of claim 1, wherein the phosphazene compound has a structure represented by the formula (I), wherein Ri to R₆ can be the same or different and can be an aryl group, an aralkyl group, a C1-12 alkoxy, a C1-12 alkyl, or a combination thereof and k is an integer from 1 to 10

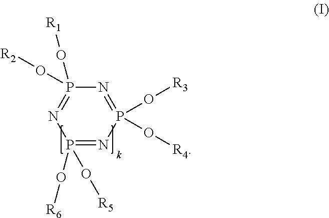

9. The flame retardant composition of claim 1, wherein the phosphazene compound comprises phenoxyphosphazene.

10. The flame retardant composition of claim 1, wherein the glass filler is at least one selection from glass fibers, glass flakes, milled glass fibers, and glass beads.

11. The flame retardant composition of claim 1, having a melt flow rate determined in accordance with ISO 1133 (300° C., 1.2 kg) of at least 9.0 cc/10 min.

12. The flame retardant composition of claim 1, further selected to have a tensile modulus determined in accordance with ISO 527 at a temperature of 23° C. of at least 3500 MPa.

13. The flame retardant composition of claim 1, further selected to have an unnotched Izod impact strength determined in accordance with ISO 180-1 U at a temperature of 23° C. of at least 30 KJ/m².

14. An article comprising or consisting of the flame retardant composition of claim 1.

15. A method of manufacturing an article comprising molding the flame retardant composition of claim 1.
